(19) United States
(12) Patent Application Publication
(10) Pub. No.: US 2024/0371174 A1
(43) Pub. Date: Nov. 7, 2024

(54) USER DETECTION APPARATUS, USER DETECTION SYSTEM, USER DETECTION METHOD, AND COMPUTER-READABLE MEDIUM

(71) Applicant: NEC Corporation, Minato-ku, Tokyo (JP)

(72) Inventor: Longshuang HUANG, Tokyo (JP)

(73) Assignee: NEC Corporation, Minato-ku, Tokyo (JP)

(21) Appl. No.: 18/689,478

(22) PCT Filed: Sep. 24, 2021
(86) PCT No.: PCT/JP2021/035094

§ 371 Date: Mar. 6, 2024

(51) Int. Cl. G06V 20/58; G06T 7/73; G06V 10/70; G06V 40/10; G06V 40/20

(52) U.S. Cl. CPC G06V 20/58; G06T 7/73; G06V 10/70; G06V 40/10; G06V 40/20; G06T 2207/20081; G06T 2207/30196; G06T 2207/30252

(57) ABSTRACT

A user detection apparatus according to the present disclosure includes: an image processing unit configured to detect a predetermined landmark based on an image obtained by photographing a vicinity of a vehicle, the predetermined landmark indicating a user candidate and a getting-on place; and a determination unit configured to determine whether the user candidate is a user of the vehicle or not based on the information on the user candidate and the predetermined landmark detected by the image processing unit.

### TECHNICAL FIELD

The present disclosure relates to a user detection apparatus, a user detection system, a user detection method, and a computer-readable medium.

### BACKGROUND ART

As related art, Patent Literature 1 discloses an outside-vehicle information providing apparatus that provides a driver with information on the presence of a person outside a vehicle who wishes to convey his or her intention to a driver. The outside-vehicle information providing apparatus described in Patent Literature 1 supports a bus driver in finding a bus user, for example.

When supporting the finding of a user of a bus, a taxi, or the like, the accuracy of user detection can be improved by using not only information on user candidates but also positional information of predetermined landmarks, such as bus stops and taxi stands, for example.

### CITATION LIST

### Patent Literature

Patent Literature 1: Japanese Unexamined Patent Application Publication No. 2018-030499

### SUMMARY OF INVENTION

### Technical Problem

A positional information acquisition system using artificial satellites or the like, for example, is used to acquire positional information of predetermined landmarks. However, the positional information provided by the positional information acquisition system may contain errors that may impede user detection, resulting in a decrease in the accuracy of user detection.

In view of the problem described above, an object of the present disclosure is to provide a user detection apparatus, a user detection system, a user detection method, and a computer-readable medium capable of improving accuracy of user detection.

### Solution to Problem

The present disclosure provides a user detection apparatus including: an image processing unit configured to detect a predetermined landmark based on an image obtained by photographing a vicinity of a vehicle, the predetermined landmark indicating a user candidate and a getting-on place; and
a determination unit configured to determine whether the user candidate is a user of the vehicle or not based on the information on the user candidate and the predetermined landmark detected by the image processing unit.

The present disclosure also provides a user detection system including:
an onboard device; and
a server apparatus, wherein
the onboard device is configured to photograph an image of a vicinity of a vehicle, and
the server apparatus is configured to determine whether a user candidate is a user of the vehicle based on the user candidate and a predetermined landmark indicating a getting-on place, the user candidate and the predetermined landmark being detected by image processing on the image.

The present disclosure also provides a user detection method including:
recognizing a user candidate and a predetermined landmark based on an image of a vicinity of a vehicle, the predetermined landmark indicating a getting-on place; and
determining whether the user candidate is a user of the vehicle or not based on information on the recognized user candidate and the recognized predetermined landmark.

The present disclosure provides a computer-readable medium recording a user detection program, the user detection program causing a computer to execute:
an operation of recognizing a user candidate and a predetermined landmark based on an image of a vicinity of a vehicle, the predetermined landmark indicating a getting-on place; and
an operation of determining whether the user candidate is a user of the vehicle or not based on information on the recognized user candidate and the recognized predetermined landmark.

### Advantageous Effects of Invention

According to the present disclosure, it is possible to provide a user detection apparatus, a user detection system, a user detection method, and a computer-readable medium capable of improving accuracy of user detection.

### BRIEF DESCRIPTION OF DRAWINGS

FIG. 1 is a block diagram illustrating a configuration of a user detection apparatus according to a first example embodiment.

FIG. 2 is a flowchart illustrating an operation of the user detection apparatus according to the first example embodiment.

FIG. 3 is a block diagram illustrating a configuration of a user detection apparatus according to a second example embodiment.

FIG. 4 is a block diagram illustrating a configuration of the user detection apparatus according to the second example embodiment.

FIG. 5 is a flowchart illustrating an operation of the user detection apparatus according to the second example embodiment.

FIG. 6 is a block diagram illustrating a configuration of a user detection apparatus according to a third example embodiment.

FIG. 7 is a block diagram illustrating a configuration of a user detection apparatus according to a fourth example embodiment.

FIG. 8 is a block diagram illustrating a configuration of a user detection apparatus according to a fifth example embodiment.

### EXAMPLE EMBODIMENTS

### First Example Embodiment

### <Configuration of User Detection Apparatus>

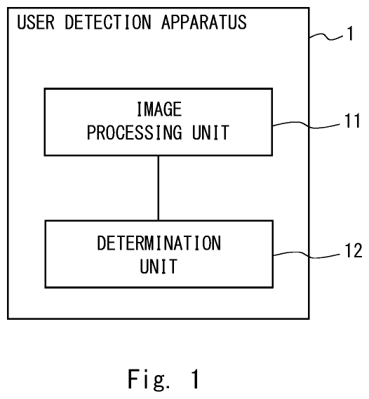

A configuration of a user detection apparatus according to a first example embodiment will be described with reference to the drawing. FIG. 1 is a block diagram illustrating the configuration of the user detection apparatus according to the first example embodiment.

A user detection apparatus 1 according to the present embodiment includes an image processing unit 11 and a determination unit 12. The image processing unit 11 is configured to detect a user candidate and a predetermined landmark based on an image obtained by photographing a vicinity of a vehicle. In addition, the determination unit 12 is configured to determine whether the user candidate is a user of the vehicle or not based on information on the predetermined landmark detected by the image processing unit 11, which indicates a user candidate and a getting-on place.

### <Operation of User Detection Apparatus>

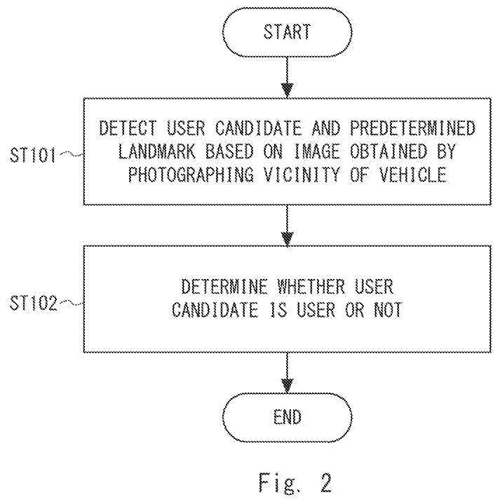

An operation of the user detection apparatus according to the first example embodiment will be described with reference to the drawing. FIG. 2 is a flowchart illustrating the operation of the user detection apparatus according to the first example embodiment.

First, the image processing unit 11 detects a user candidate and a predetermined landmark based on an image obtained by photographing a vicinity of a vehicle (Step ST101). Next, the determination unit 12 determines whether the user candidate is a user of the vehicle or not (Step ST102).

With such a configuration, the user detection apparatus 1 according to the present embodiment detects not only a user candidate in an image but also a predetermined landmark therein, whereby it is possible to acquire a positional relation between the user candidate and the predetermined landmark with accuracy. As a result, the user detection apparatus 1 can improve accuracy of user detection.

### Second Example Embodiment

### <Configuration of User Detection Apparatus>

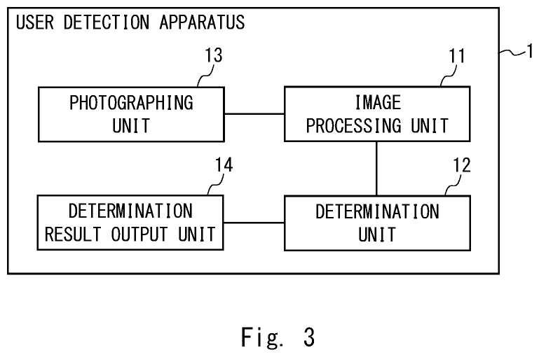

A configuration of a user detection apparatus according to a second example embodiment will be described in detail with reference to the drawings. FIG. 3 is a block diagram illustrating a configuration of a user detection apparatus according to the second example embodiment.

A user detection apparatus 1 according to the present embodiment is an apparatus attached to a vehicle, such as a bus or a taxi, which needs to discover or detect a user, for example. The user detection apparatus 1 includes an image processing unit 11, the determination unit 12, a photographing unit 13, and a determination result output unit 14.

Note that, in the present embodiment, the user detection apparatus 1 does not necessarily have to be configured as one physical apparatus. For example, the image processing unit 11, the determination unit 12, the photographing unit 13, and the determination result output unit 14 may be distributed and arranged in a plurality of physical apparatuses. In addition, the image processing unit 11, the determination unit 12, the photographing unit 13, and the determination result output unit 14 may each be configured as separate devices.

The photographing unit 13 photographs an image of a vicinity of a vehicle, and outputs it to the image processing unit 11. The vicinity of the vehicle mentioned herein may include, for example, an area on a sidewalk that exists in a direction of travel of the vehicle. That is, it is preferable to include left front of the vehicle in a photographing range when the vehicle is driving on the left side, and it is preferable to include right front of the vehicle in the photographing range when the vehicle is driving on the right side.

When a vehicle finds a user, the vehicle must stop in the vicinity of the user. For that reason, at a stage when the vehicle acquires user information detected by the user detection apparatus 1, it is required a distance between the vehicle and the user, which allows the vehicle to perform a stop operation safely. Therefore, the area photographed by the photographing unit 13 may include an area farther from the vehicle than the distance required for the vehicle to perform the stop operation safely.

The photographing unit 13 may be one camera provided in the vehicle, or may be plurality of cameras. For example, the photographing unit 13 may be a plurality of cameras installed at two or more of four directions including the front, right and left sides and rear of the vehicle.

The image processing unit 11 acquires, from the photographing unit 13, the image obtained by photographing the vicinity of the vehicle. The image processing unit 11 performs image processing on the acquired image, and detects a user candidate and a predetermined landmark. The image processing unit 11 may detect a state of the user candidate by the image processing. In addition, the image processing unit 11 may detect a distance between the detected user candidate and the detected predetermined landmark. The image processing unit 11 outputs, to the determination unit 12, information on the detected user candidate and the detected predetermined landmark.

For example, the image processing unit 11 searches for a region of a person in the acquired image, and detects a user candidate. In a case where a plurality of persons in the image, the image processing unit 11 detects the plurality of persons as user candidates. In addition, the state of the user candidate indicates information such as a position, an action, or the like of the user candidate, for example.

In addition, in the image processing, the image processing unit 11 detects, for example, a landmark for indicating a getting-on place as a predetermined landmark. In a case where the vehicle is a bus, for example, the image processing unit 11 detects a bus stop as the predetermined landmark.

In addition, in a case where the vehicle is a taxi, for example, the image processing unit 11 may detect a display board representing a taxi stand as the predetermined landmark. Alternatively, in a case where a user designates a characteristic object, such as a structure or a signboard, as a characteristic object in the vicinity of a meeting spot, the image processing unit 11 may detect the designated characteristic object as the predetermined landmark.

In addition, the image processing unit 11 may include an AI (artificial intelligence) engine. The AI engine leans so as to detect a person and a state of the person from an image, for example. The image processing unit 11 inputs the acquired image into the AI engine, and acquires a detection result of the user candidate from the AI engine.

The determination unit 12 acquires, from the image processing unit 11, information regarding the state of the user candidate and the distance between the user candidate and the predetermined landmark. Then, the determination unit 12 determines whether the user candidate is a user of the vehicle or not based on the state of the user candidate and the distance between the user candidate and the predetermined landmark.

Specifically, the determination unit 12 determines whether the distance between the user candidate and the predetermined landmark is smaller than or equal to a predetermined value or not. In a case where a plurality of user candidates is detected, the determination unit 12 determines, for each of the plurality of user candidates, whether the distance is smaller than or equal to the predetermined value.

Next, the determination unit 12 determines, for the user candidate whose distance to the predetermined landmark is determined to be smaller than or equal to the predetermined value, whether the state of the user candidate satisfies a predetermined condition or not. Then, the determination unit 12 determines that the user candidate that satisfies the predetermined condition is a user. When the determination unit 12 determines that at least one or more user candidates are users, the determination unit 12 outputs information on the users to the determination result output unit 14.

The predetermined condition for the state of the user candidate mentioned herein may be a situation that a user candidate stays in the same location, for example. That is, when a state where a user candidate is waiting in the vicinity of a predetermined landmark is detected, it may be determined that the user candidate is a user. Note that the word “stay in the same location” does not mean that the user candidate completely and strictly stops at one point, but movement is allowed within a range that does not deviate from the purpose.

In addition, the predetermined condition for the state of the user candidate may be a situation that a plurality of user candidates are gathered. That is, the determination unit 12 may count the number of user candidates whose distance to a predetermined landmark is determined to be smaller than or equal to a predetermined value. In a case where the number of user candidates is equal to or greater than the predetermined number, the determination unit 12 may determine that all user candidates are users.

In addition, the predetermined condition for the state of the user candidate may be a situation that user candidates are lined up. That is, in a case where user candidates whose distance to a predetermined landmark is determined to be smaller than or equal to a predetermined value are lined up in a straight line starting with one of the user candidates, the determination unit 12 may determine that all user candidates are users.

Note that, in a case where some of user candidates lined up in a straight line are user candidates whose distance to a predetermined landmark is determined to be larger than a predetermined value, the determination unit 12 may also determine that such user candidates are users. In addition, the word “lined up in a straight line” does not necessarily mean a strict straight line, and includes cases where the arrangement is distorted within a range that does not deviate from the purpose.

In addition, the predetermined condition for the state of the user candidate may be a situation that the user candidate is performing a predetermined action. The predetermined action mentioned herein may be, for example, a motion of raising a hand or a motion of following a vehicle with the eyes. That is, the predetermined action may be any action that can be detected by the image processing unit 11.

In addition, the predetermined condition for the state of the user candidate is not limited to one, and a plurality of conditions may be set. Then, in a case where any one or more conditions are detected, the determination unit 12 may determines the user candidate as a user.

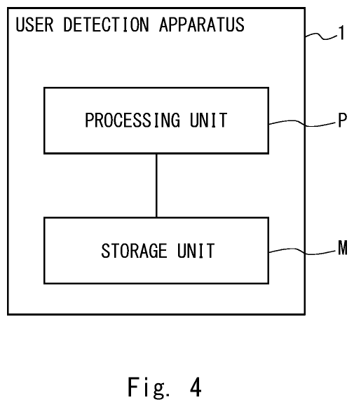

As illustrated in FIG. 4, for example, the image processing unit 11 and the determination unit 12 may be realized by a processing unit P such as a Central Processing Unit (CPU) and a storage unit M, such as a Random Access Memory (RAM) or a Read Only Memory (ROM), in which programs, data, and the like for controlling the processing unit are stored. Alternatively, the image processing unit 11 and the determination unit 12 may be realized as a single device or component. That is, the image processing unit 11 and the determination unit 12 may be realized as software or hardware.

Note that a program includes a set of instructions (or software codes) that, when read into a computer, causes the computer to perform one or more of the functions described in the example embodiments. The program may be stored in a non-transitory computer readable medium or in a physical storage medium. By way of example rather than limitation, a computer readable medium or a physical storage medium may include a random-access memory (RAM), a read-only memory (ROM), a flash memory, a solid-state drive (SSD), or other memory technology, a CD-ROM, a digital versatile disc (DVD), a Blu-ray (registered trademark) disc or other optical disc storages, a magnetic cassette, magnetic tape, and a magnetic disc storage or other magnetic storage devices. The program may be transmitted on a transitory computer readable medium or a communication medium. By way of example rather than limitation, the transitory computer readable medium or the communication medium may include electrical, optical, acoustic, or other forms of propagating signals.

The determination result output unit 14 informs information on the users acquired from the determination unit 12. A target to which the determination result output unit 14 informs the information on the users is, for example, a driver of the vehicle or a self-driving control system installed in the vehicle.

In a case where the target to which the information on the users is informed is the driver of the vehicle, for example, the determination result output unit 14 may inform the information on the users by voice, or may inform the information on the users by lighting or blinking a light source such as a lamp. In this case, the determination result output unit 14 may merely inform the driver of the presence of the user, or may also inform the driver of information on a location of the user and the number of users.

In addition, in a case where the target to which the information on the users is informed is the self-driving control system installed in the vehicle, the determination result output unit 14 may output positional information of the user to the self-driving control system.

With such a configuration, the user detection apparatus 1 according to the present embodiment detects the predetermined landmark by the image processing. Therefore, the accuracy of the positional information of the predetermined landmark is improved. Moreover, since the user is determined from the user candidates based on the acquired positional information of the predetermined landmark, it is possible to improve the accuracy of the user detection.

### <Operation of User Detection Apparatus>

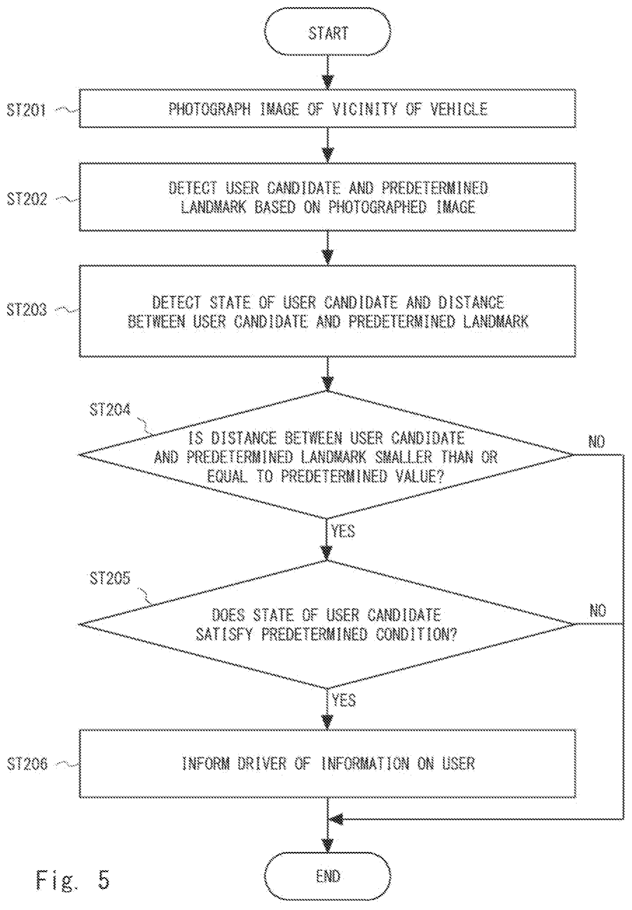

An operation of the user detection apparatus according to the second example embodiment, that is, a user detection method will be described in detail with reference to the drawing. FIG. 5 is a flowchart illustrating the operation of the user detection apparatus according to the second example embodiment.

First, the photographing unit 13 photographs an image of a vicinity vehicle (Step ST201). Next, the image processing unit 11 detects a user candidate and a predetermined landmark based on the photographed image (Step ST202), and detects a state of the user candidate and a distance between the user candidate and the predetermined landmark (Step ST203).

Next, the determination unit 12 determines whether the distance between the user candidate and the predetermined landmark is smaller than or equal to a predetermined value or not (Step ST204). In a case where it is determined that the distance between the user candidate and the predetermined landmark is larger than the predetermined value, that is, in a case where the determination at Step ST204 is No, the determination unit 12 determines that the user candidate is not a user, and terminates a series of processes.

In a case where it is determined that the distance between the user candidate and the predetermined landmark is smaller than or equal to the predetermined value, that is, in a case where the determination at Step ST204 is Yes, the determination unit 12 determine whether a state of the user candidate satisfies a predetermined condition or not (Step ST205). In a case where it is determined that the state of the user candidate does not satisfy the predetermined condition, that is, in a case where the determination at Step ST205 is No, the determination unit 12 determines that the user candidate is not a user, and terminates the series of processes.

In a case where it is determined that the state of the user candidate satisfies the predetermined condition, that is, in a case where the determination at Step ST205 is Yes, the determination result output unit 14 informs a driver of information on the user (Step ST206), and terminates the series of processes. The series of processes described above is executed repeatedly while the user detection apparatus 1 is in operation.

Note that the number of user candidates determined by the series of processes described above differs depending upon the predetermined condition at Step ST205. For example, in a case where the predetermined condition is that a user candidate stays in the same location or that a user candidate is performing a predetermined action, the series of processes is executed for each user candidate.

On the other hand, in a case where the predetermined condition is that the number of user candidates is greater than or equal to a predetermined number or that user candidates are lined up, for example, the series of processes is executed for a plurality of user candidates as a target.

With the configuration described above, the user detection apparatus 1 according to the present embodiment can improve the accuracy of the user detection, and inform the driver or the self-driving control system of the detected user information.

### Third Example Embodiment

### <Configuration of User Detection System>

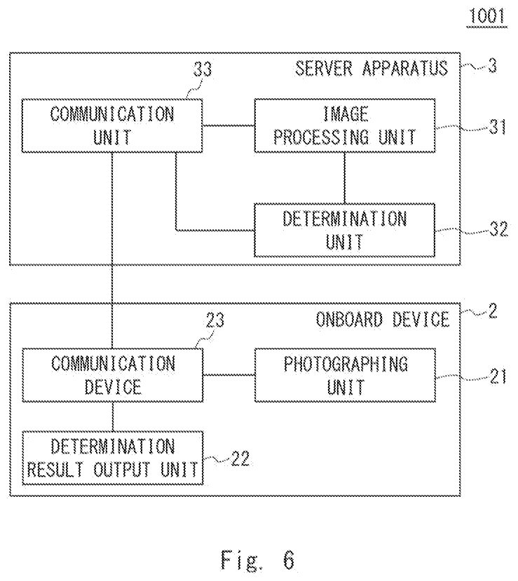

A configuration of a user detection apparatus according to a third example embodiment will be described in detail with reference to the drawing. Note that, in the following example embodiments, description that overlaps with that in the first or second example embodiment will be omitted as appropriate. FIG. 6 is a block diagram illustrating a configuration of a user detection system according to the third example embodiment.

A user detection system 1001 according to the present embodiment includes an onboard device 2 and a server apparatus 3. The onboard device 2 and the server apparatus 3 can communicate with each other via a network including a wireless communication network. The user detection system 1001 according to the present embodiment causes the server apparatus 3 that is not installed in a vehicle to perform some of the functions of the user detection apparatus 1 according to the first or second example embodiment. Specifically, the server apparatus 3 according to the present embodiment executes functions corresponding to the image processing unit 11 and the determination unit 12 according to the first or second example embodiment.

Note that, although the example in which the server apparatus executes the functions corresponding to the image processing unit and the determination unit has been described in the above description, the present embodiment is not limited to this. For example, the onboard device 2 may execute the functions corresponding to the image processing unit 11 according to the first or second example embodiment, and the server apparatus 3 may execute only the functions corresponding to the determination unit 12 according to the first or second example embodiment.

That is, the onboard device 2 only needs to have at least a function of photographing an image of a vicinity of the vehicle, and the server apparatus 3 only needs to have at least a function of determining whether a user candidate is a user of the vehicle or not based on a user candidate and a predetermined landmark detected by image processing.

The onboard device 2 includes a photographing unit 21, a determination result output unit 22, and a communication device 23. The photographing unit 21 corresponds to the photographing unit 13 according to the second example embodiment, and has the similar configuration and function. In addition, the determination result output unit 22 corresponds to the determination result output unit 14 according to the second example embodiment, and has the similar configuration and function. The communication device 23 transmits the image photographed by the photographing unit 21 to the server apparatus 3. In addition, the communication device 23 receives information on a user from the server apparatus 3, and outputs it to the determination result output unit 22.

The server apparatus 3 includes an image processing unit 31, a determination unit 32, and a communication unit 33. The image processing unit 31 corresponds to the image processing unit 11 according to the first or second example embodiment, and has the similar configuration and function. The determination unit 32 corresponds to the determination unit 12 according to the first or second example embodiment, and has the similar configuration and function. The communication unit 33 receives the image from the onboard device 2, and outputs it to the image processing unit 31. In addition, the communication unit 33 transmits the information on the user outputted by the determination unit 32 to the onboard device 2.

Thus, in a case where the server apparatus 3 is caused to execute some of the functions of the user detection apparatus 1 according to the first or second example embodiment, it is possible to reduce the cost because equipment installed in the vehicle is simplified.

### Fourth Example Embodiment

### <Configuration of User Detection System>

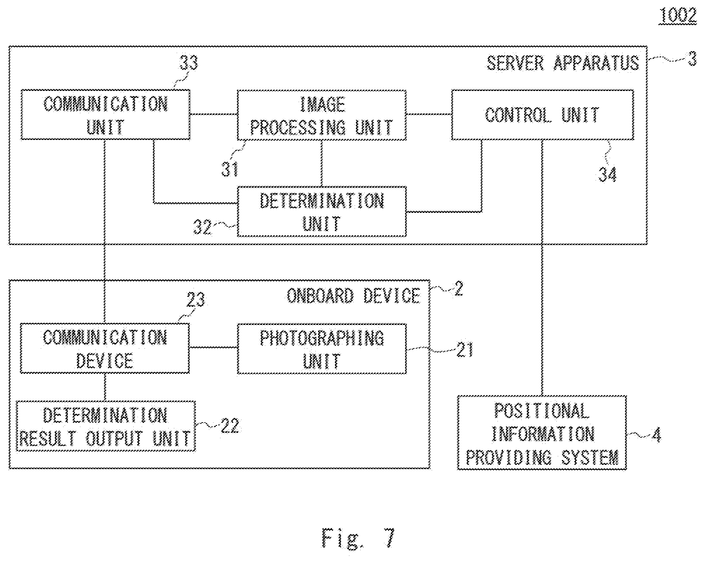

A fourth example embodiment is a first application example of the user detection system 1001 according to the third example embodiment. A configuration of a user detection system according to the fourth example embodiment will be described in detail with reference to the drawing. FIG. 7 is a block diagram illustrating the configuration of the user detection system according to the fourth example embodiment.

A user detection system 1002 according to the present embodiment is obtained by adding a positional information providing system 4 and a control unit 34 (will be described later) to the user detection system 1001 according to the third example embodiment. Note that the positional information providing system 4 and the control unit 34 are elements that can be applied to the user detection apparatus 1 according to the first or second example embodiment.

The positional information providing system 4 is a positional information providing system using artificial satellites such as GNSS (Global Navigation Satellite System), for example, and outputs information on a current location of a vehicle and positional information of a predetermined landmark to the control unit 34. Specifically, the positional information providing system 4 includes a position measuring unit mounted on the vehicle and a transmission unit configured to transmit positional information of the vehicle acquired by the position measuring unit to the control unit 34, which are not illustrated in the drawing.

The control unit 34 acquires the information on the current location of the vehicle from the positional information providing system 4. Then, the control unit 34 controls an image processing unit 31 and a determination unit 32 based on the information on the current location of the vehicle and positional information of a predetermined landmark stored in advance by the control unit 34.

Specifically, the control unit 34 estimates a distance between the vehicle and the predetermined landmark, and determines whether the estimated distance is smaller than or equal to a predetermined distance or not. Then, in a case where the estimated distance is smaller than or equal to the predetermined distance, the control unit 34 operates the image processing unit 31 and the determination unit 32. Further, in a case where the estimated distance is greater than the predetermined distance, the control unit 34 does not operate the image processing unit 31 and the determination unit 32.

With such a configuration, it is possible to appropriately limit the range in which the user is to be detected, and this makes it possible to suppress false detection of the user.

### Fifth Example Embodiment

### <Configuration of User Detection System>

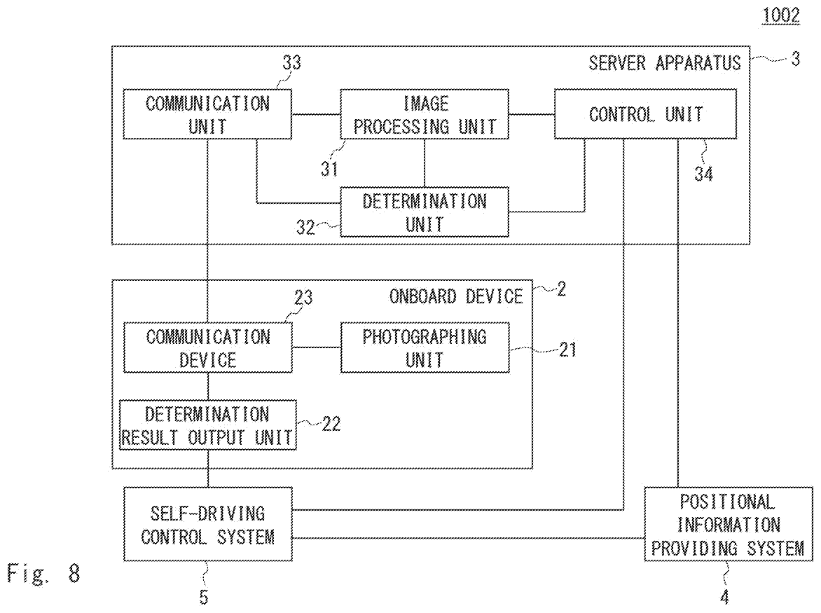

A fifth example embodiment is a second application example of the user detection system according to the third example embodiment. A configuration of a user detection system according to the fifth example embodiment will be described in detail with reference to the drawing. FIG. 8 is a block diagram illustrating the configuration of the user detection system according to the fifth example embodiment.

A user detection system 1003 according to the fifth example embodiment is obtained by applying the user detection system according to the fourth example embodiment to a vehicle equipped with a self-driving control system 5.

The self-driving control system 5 receives a location of a predetermined landmark from a control unit 34, and drives the vehicle toward the location of the predetermined landmark based on positional information provided from a positional information providing system 4. Then, the self-driving control system 5 acquires positional information of a user from a determination result output unit 22, and drives the vehicle so as to stop in the vicinity of the user.

Thus, the user detection system according to the present disclosure can also be applied to user detection of the vehicle equipped with the self-driving control system.

The present invention has been described with reference to the example embodiments (and examples). However, the present invention is not limited to the example embodiments (and examples) described above. Various changes that can be understood by those skilled in the art can be made to the configurations and details of the present disclosure within the scope of the present disclosure.

For example, some or all of the example embodiments described above can be described as the following supplementary notes, but are not limited to the following supplementary notes.

### (Supplementary Note 1)

A user detection apparatus comprising:
an image processing unit configured to detect a predetermined landmark based on an image obtained by photographing a vicinity of a vehicle, the predetermined landmark indicating a user candidate and a getting-on place; and
a determination unit configured to determine whether the user candidate is a user of the vehicle or not based on the information on the user candidate and the predetermined landmark detected by the image processing unit.

### (Supplementary Note 2)

The user detection apparatus according to Supplementary Note 1, wherein
the image processing unit is further configured to detect a state of the user candidate and a distance between the user candidate and the predetermined landmark, and
the determination unit is further configured to determine whether the user candidate is a user of the vehicle or not based on the state of the user candidate and the distance between the user candidate and the predetermined landmark.

### (Supplementary Note 3)

The user detection apparatus according to Supplementary Note 2, wherein
the determination unit is further configured to determine that the user candidate is the user in a case where the distance between the user candidate and the predetermined landmark is equal to or shorter than a predetermined value and the user candidate stays in a same location as the state of the user candidate.

### (Supplementary Note 4)

The user detection apparatus according to Supplementary Note 2 or 3, wherein
the determination unit is further configured to determine that the user candidate is the user in a case where the distance between the user candidate and the predetermined landmark is equal to or shorter than a predetermined value and a number of user candidates is equal to or more than a predetermined number as the state of the user candidate.

### (Supplementary Note 5)

The user detection apparatus according to any one of Supplementary Notes 2 to 4, wherein
the determination unit is further configured to determine that the user candidate is the user in a case where the distance between the user candidate and the predetermined landmark is equal to or shorter than a predetermined value and a plurality of the user candidates lines up as the state of the user candidate.

### (Supplementary Note 6)

The user detection apparatus according to any one of Supplementary Notes 2 to 5, wherein
the determination unit is further configured to determine that the user candidate is the user in a case where the distance between the user candidate and the predetermined landmark is equal to or shorter than a predetermined value and the user candidate is performing a predetermined action as the state of the user candidate.

### (Supplementary Note 7)

The user detection apparatus according to any one of Supplementary Notes 1 to 6, wherein
the vehicle is a bus, and
the image processing unit is further configured to detect a bus stop as the predetermined landmark.

### (Supplementary Note 8)

The user detection apparatus according to any one of Supplementary Notes 1 to 6, further comprising:
a determination result output unit, wherein
the vehicle is a vehicle driven by a control of a driver, and
the determination result output unit is configured to inform the driver of presence of the user in a case where the determination unit determines that the user candidate is the user.

### (Supplementary Note 9)

The user detection apparatus according to Supplementary Note 7, wherein a number of users is informed of the driver.

### (Supplementary Note 10)

The user detection apparatus according to any one of Supplementary Notes 1 to 6, further comprising:
a determination result output unit, wherein
the determination result output unit is configured to output positional information of the user to a self-driving control system in a case where the vehicle is a vehicle driven by a control of the self-driving control system and the determination unit determines that the user candidate is the user.

### (Supplementary Note 11)

The user detection apparatus according to any one of Supplementary Notes 1 to 9, wherein
a distance between the vehicle and the predetermined landmark is estimated based on positional information of the vehicle,
the image processing unit and the determination unit are operated in a case where the estimated distance is equal to or shorter than a predetermined distance, and
the image processing unit and the determination unit are not operated in a case where the estimated distance is longer than the predetermined distance.

### (Supplementary Note 12)

The user detection apparatus according to any one of Supplementary Notes 1 to 10, wherein
the image processing unit includes an AI (artificial intelligence) engine,
the AI engine is configured to:
   learn an image of the predetermined landmark or an image of something similar to the predetermined landmark; and
   assist detection of the predetermined landmark.

### (Supplementary Note 13)

A user detection system comprising:
an onboard device; and
a server apparatus, wherein
the onboard device is configured to photograph an image of a vicinity of a vehicle, and
the server apparatus is configured to determine whether a user candidate is a user of the vehicle based on the user candidate and a predetermined landmark indicating a getting-on place, the user candidate and the predetermined landmark being detected by image processing on the image.

### (Supplementary Note 14)

The user detection apparatus according to Supplementary Note 12, wherein
the onboard device includes a plurality of cameras respectively installed at front, right, and left sides of the vehicle.

### (Supplementary Note 15)

A user detection method comprising:
recognizing a user candidate and a predetermined landmark based on an image of a vicinity of a vehicle, the predetermined landmark indicating a getting-on place; and
determining whether the user candidate is a user of the vehicle or not based on information on the recognized user candidate and the recognized predetermined landmark.

### (Supplementary Note 16)

A computer-readable medium recording a user detection program, the user detection program causing a computer to execute:
an operation of recognizing a user candidate and a predetermined landmark based on an image of a vicinity of a vehicle, the predetermined landmark indicating a getting-on place; and
an operation of determining whether the user candidate is a user of the vehicle or not based on information on the recognized user candidate and the recognized predetermined landmark.

### REFERENCE SIGNS LIST

1 USER DETECTION APPARATUS
2 ONBOARD DEVICE
3 SERVER APPARATUS
4 POSITIONAL INFORMATION PROVIDING SYSTEM
5 SELF-DRIVING CONTROL SYSTEM
11, 31 IMAGE PROCESSING UNIT
12, 32 DETERMINATION UNIT
13, 21 PHOTOGRAPHING UNIT
14, 22 DETERMINATION RESULT OUTPUT UNIT
23 COMMUNICATION DEVICE
33 COMMUNICATION UNIT
34 CONTROL UNIT
1001, 1002, 1003 USER DETECTION SYSTEM

What is claimed is:

1. A user detection apparatus comprising:
at least one memory storing instructions; and
at least one processor configured to execute the instructions to:
detect a predetermined landmark based on an image obtained by photographing a vicinity of a vehicle, the predetermined landmark indicating a user candidate and a getting-on place; and
determine whether the user candidate is a user of the vehicle or not based on the information on the user candidate and the predetermined landmark detected by the image processing unit.

2. The user detection apparatus according to claim 1, wherein
the at least one processor is further configured to:
detect a state of the user candidate and a distance between the user candidate and the predetermined landmark, and
determine whether the user candidate is a user of the vehicle or not based on the state of the user candidate and the distance between the user candidate and the predetermined landmark.

3. The user detection apparatus according to claim 2, wherein
the at least one processor is further configured to determine that the user candidate is the user in a case where the distance between the user candidate and the predetermined landmark is equal to or shorter than a predetermined value and the user candidate stays in a same location as the state of the user candidate.

4. The user detection apparatus according to claim 2, wherein
the at least one processor is further configured to determine that the user candidate is the user in a case where the distance between the user candidate and the predetermined landmark is equal to or shorter than a predetermined value and a number of user candidates is equal to or more than a predetermined number as the state of the user candidate.

5. The user detection apparatus according to claim 2, wherein
the at least one processor is further configured to determine that the user candidate is the user in a case where the distance between the user candidate and the predetermined landmark is equal to or shorter than a predetermined value and a plurality of the user candidates lines up as the state of the user candidate.

6. The user detection apparatus according to claim 2, wherein
the at least one processor is further configured to determine that the user candidate is the user in a case where the distance between the user candidate and the predetermined landmark is equal to or shorter than a predetermined value and the user candidate is performing a predetermined action as the state of the user candidate.

7. The user detection apparatus according to claim 1, wherein
the vehicle is a bus, and
the at least one processor is further configured to detect a bus stop as the predetermined landmark.

8. The user detection apparatus according to claim 1, wherein
the vehicle is a vehicle driven by a control of a driver, and
the at least one processor is configured to inform the driver of presence of the user in a case where the determination unit determines that the user candidate is the user.

9. The user detection apparatus according to claim 8, wherein
a number of users is informed of the driver.

10. The user detection apparatus according to claim 1, wherein
the at least one processor is configured to output positional information of the user to a self-driving control system in a case where the vehicle is a vehicle driven by a control of the self-driving control system and the determination unit determines that the user candidate is the user.

11. The user detection apparatus according to claim 1, wherein
a distance between the vehicle and the predetermined landmark is estimated based on positional information of the vehicle, and
the at least one processor is configured to detect the predetermined landmark and determine whether the user candidate is a user of the vehicle or not in a case where the estimated distance is equal to or shorter than a predetermined distance.

12. The user detection apparatus according to claim 1, wherein
the at least one processor includes an AI (artificial intelligence) engine,
the AI engine is configured to:
learn an image of the predetermined landmark or an image of something similar to the predetermined landmark; and
assist detection of the predetermined landmark.

13. A user detection system comprising:
an onboard device; and
a server apparatus, wherein
the onboard device is configured to photograph an image of a vicinity of a vehicle, and
the server apparatus is configured to determine whether a user candidate is a user of the vehicle based on the user candidate and a predetermined landmark indicating a getting-on place, the user candidate and the predetermined landmark being detected by image processing on the image.

14. The user detection system according to claim 13, wherein
the onboard device includes a plurality of cameras respectively installed at front, right, and left sides of the vehicle.

15. A user detection method comprising:
recognizing a user candidate and a predetermined landmark based on an image of a vicinity of a vehicle, the predetermined landmark indicating a getting-on place; and
determining whether the user candidate is a user of the vehicle or not based on information on the recognized user candidate and the recognized predetermined landmark.

16. (canceled)
